(19) United States
(12) Patent Application Publication
(10) Pub. No.: US 2012/0206786 A1
(43) Pub. Date: Aug. 16, 2012

(54) LASER LIGHT SHAPING AND WAVEFRONT CONTROLLING OPTICAL SYSTEM

(75) Inventors: Haruyasu ITO, Hamamatsu-shi (JP); Takashi Yasuda, Hamamatsu-shi (JP)

(73) Assignee: HAMAMATSU PHOTONICS K.K., Hamamatsu-shi (JP)

(21) Appl. No.: 13/357,924

(22) Filed: Jan. 25, 2012

(30) Foreign Application Priority Data
Feb. 14, 2011 (JP) 2011-028946

(51) Int. Cl. G02F 1/01

(52) U.S. Cl. 359/238

(57) ABSTRACT

A laser light shaping and wavefront controlling optical system 1 in accordance with an embodiment of the present invention comprises an intensity conversion lens 11 for converging and shaping an intensity distribution of laser light incident thereon into a desirable intensity distribution; a light modulator 12 for modulating the laser light emitted from the intensity conversion lens 11 so as to perform wavefront control; and an expansion/reduction optical system 20, arranged between the intensity conversion lens 11 and the light modulator 12, for expanding or reducing the laser light emitted from the intensity conversion lens 11.

### BACKGROUND OF THE INVENTION

1. Field of the Invention

The present invention relates to an optical system which shapes an intensity distribution of laser light into a given intensity distribution and controls the wavefront of the laser light.

2. Related Background Art

Laser light typically has an intensity distribution which is the strongest near its center and gradually becomes weaker toward peripheries as in a Gaussian distribution. However, laser light having a spatially uniform intensity distribution has been desired for laser processing and the like.

In this regard, Patent Literature 1 discloses, as a laser light shaping optical system for shaping an intensity distribution of laser light into a spatially uniform intensity distribution (e.g., a top-hat intensity distribution), one comprising an aspherical lens type homogenizer constituted by an intensity conversion lens and a phase correction lens. The laser light shaping optical system disclosed in Patent Literature 1 further comprises an image-forming optical system (transfer lens system) on the downstream side of the homogenizer in order to suppress the unevenness in the intensity distribution caused by positional deviations between the intensity conversion lens and the phase correction lens.

Patent Literature 2 discloses, as a laser light shaping optical system for shaping the intensity distribution of laser light into a spatially uniform intensity distribution, one comprising the above-mentioned aspherical lens type homogenizer, a diffractive homogenizer constituted by a diffractive optical element (DOE), or the like. The laser light shaping optical system disclosed in Patent Literature 2 further comprises, on the downstream side of the homogenizer, an image-forming optical system constituted by an objective lens and an image-forming lens arranged behind the objective lens. For reducing the total length of the laser light shaping optical system, the objective lens is arranged in front of a focal plane of the homogenizer, so as to have a negative focal length.

It is desirable for laser processing and the like to be able to perform fine processing. When forming a modified layer such as an optical waveguide, for example, converging points are desired to be as small as possible. When the processing position is deeper, however, aberrations (wavefront distortions) cause converging regions to expand, thereby making it harder to keep a favorable processing state.

In this regard, Patent Literatures 3 and 4 disclose, as an optical system for correcting aberrations of laser light, i.e., as a wavefront controlling optical system for controlling the wavefront of laser light, one comprising a spatial light modulator (SLM). The wavefront controlling optical system disclosed in Patent Literature 3 further comprises an adjustment optical system (image-forming optical system) between the SLM and a condenser optical system in order for the SLM and the condenser optical system to yield the same wavefront form.

Here, for shaping the intensity distribution of laser light into a spatially uniform intensity distribution and controlling the wavefront of the laser light at the same time, the SLM mentioned in Patent Literature 3 or 4 may be employed in the optical system disclosed in Patent Literature 1 or 2. Preferably, for enhancing the modulating efficiency of the SLM in this case, the laser light is expanded or reduced such that the size of the laser light is substantially identical to that of the modulation surface.

In this regard, the laser light shaping optical systems disclosed in Patent Literatures 1 and 2 seem to be able to easily expand or reduce the laser light by using the image-forming optical system disposed behind the homogenizer. That is, the SLM may be placed behind the homogenizer, while the image-forming optical system may be disposed between the homogenizer and the SLM. Preferably, in this case, the entrance-side imaging plane and exit-side imaging plane of the image-forming optical system are set as the exit surface of the homogenizer and the modulation surface of the SLM, respectively.
Patent Literature 1: Japanese Patent Application Laid-Open No. 2007-310368
Patent Literature 2: Japanese Patent Application Laid-Open No. 2007-114741
Patent Literature 3: Japanese Patent Application Laid-Open No. 2009-034723
Patent Literature 4: Japanese Patent Application Laid-Open No. 2010-075997

### SUMMARY OF THE INVENTION

Arranging an expansion/reduction optical system between the homogenizer and the SLM as mentioned above may be problematic in that the number of parts or the optical path length increases.

In this regard, the inventors have tried to eliminate phase correction lenses in homogenizers, so as to perform phase correction by the SLM alone. The inventors have has also attempted to homogenize the intensity distribution of laser light and expand or reduce the laser light at the same time by using an intensity conversion lens alone.

However, new problems have occurred as follows. That is, homogenizing the intensity distribution of laser light and expanding or reducing the laser light at the same time by the intensity conversion lens alone complicates the form of the aspheric surface of the intensity conversion lens and increases the area of the intensity conversion lens and the difference in height of the aspheric surface. As a result, the processing time required for manufacturing the intensity conversion lens becomes longer, thereby increasing the manufacturing cost and lowering the processing accuracy. Also, this kind of intensity conversion lens may not be employed in existing optical systems with limited mounting spaces.

It is therefore an object of the present invention to provide, in a laser light shaping and wavefront controlling optical system which shapes an intensity distribution of laser light into a given intensity distribution and controls the wavefront of the laser light at the same time, one which inhibits the processing time for optical lenses from being prolonged by expanding or reducing the laser light.

The laser light shaping and wavefront controlling optical system in accordance with the present invention comprises an intensity conversion lens for converging and shaping an intensity distribution of laser light incident thereon into a desirable intensity distribution; a light modulator for modulating the laser light emitted from the intensity conversion lens so as to perform wavefront control; and an expansion/reduction optical system, arranged between the intensity conversion lens and the light modulator, for expanding or reducing the laser light emitted from the intensity conversion lens.

Since this laser light shaping and wavefront controlling optical system expands or reduces laser light by using the expansion/reduction optical system arranged between the intensity conversion lens and the light modulator, it is sufficient for the intensity conversion lens to shape the intensity distribution of the laser light. This can inhibit the intensity conversion lens from increasing the difference in height in its aspheric surface, thereby keeping the intensity conversion lens from prolonging its processing time.

The expansion/reduction optical system may be constituted by a pair of convex lenses or a pair of concave and convex lenses. This structure can expand or reduce the laser light to a given size according to focal lengths of the pair of lenses.

When practical use is taken into consideration here, the expansion/reduction optical system constituted by a pair of convex lenses once converges (crosses) a beam and then expands or reduces it, which increases the optical path length and may cause air breakdown at the converging point (cross point). In terms of optical design, on the other hand, another optical element (such as a reflector for monitoring) cannot be arranged within the expansion/reduction optical system even when required, since the light intensity is so strong near the converging point that the optical element may be damaged.

By contrast, the expansion/reduction optical system constituted by a pair of concave and convex lenses has no converging point (cross point) and thus can reduce the optical path length while preventing air breakdown from occurring at the converging point. Also, optical elements arranged within the expansion/reduction optical system, if any, are not damaged, which is advantageous in that the degree of freedom in optical design is high, whereby further smaller sizes can be achieved.

Preferably, the modulation surface of the light modulator is located at a plane where the laser light emitted from the intensity conversion lens has the desirable intensity distribution. The intensity distribution shaped by the intensity conversion lens does not change drastically even when deviated from its designed value, whereby it is not necessary for the modulation surface of the light modulator to strictly coincide with the plane where the laser light emitted from the intensity conversion lens has the desirable intensity distribution. However, this structure lets the modulation surface of the light modulator strictly coincide with the plane where the laser light emitted from the intensity conversion lens has the desirable intensity distribution, whereby shaping the intensity distribution of laser light into a given intensity distribution and controlling the wavefront of the laser light can strictly be achieved at the same time.

In a laser light shaping and wavefront controlling optical system which shapes an intensity distribution of laser light into a given intensity distribution and controls the wavefront of the laser light at the same time, the present invention can inhibit the processing time for optical lenses from being prolonged by expanding or reducing the laser light.

### BRIEF DESCRIPTION OF THE DRAWINGS

FIG. 1 is a structural diagram illustrating a laser light shaping and wavefront controlling optical system in accordance with a first comparative example;

FIG. 2 is a chart illustrating respective examples of intensity distributions of input laser light and output laser light in the first comparative example;

FIG. 3 is a chart illustrating an example of forms of an intensity conversion lens;

FIG. 4 is a chart illustrating an example of intensity distributions of input laser light in the first comparative example;

FIG. 5 is a chart illustrating an example of desirable intensity distributions of output laser light in the first comparative example;

FIG. 6 is a chart illustrating an example of forms of the intensity conversion lens;

FIG. 7 is a chart illustrating an example of desirable intensity distributions of output laser light in the first comparative example;

FIG. 8 is a chart illustrating an example of forms of the intensity conversion lens;

FIG. 9 is a structural diagram illustrating the laser light shaping and wavefront controlling optical system in accordance with a first embodiment of the present invention;

FIG. 10 is a structural diagram illustrating the laser light shaping and wavefront controlling optical system in accordance with a first example;

FIG. 11 is a chart illustrating a result of measurement of the intensity distribution of input laser light;

FIG. 12 is a chart illustrating a result of design of the intensity conversion lens in the first example;

FIG. 13 is a chart illustrating a result of measurement of a desirable intensity distribution of the laser light emitted from the intensity conversion lens in the first example at a position where an SLM is arranged;

FIG. 14 is a chart illustrating a result of measurement of the wavefront of the laser light emitted from the intensity conversion lens in the first example at the position where the SLM is arranged;

FIG. 15 is a structural diagram illustrating the laser light shaping and wavefront controlling optical system in accordance with a second comparative example;

FIG. 16 is a chart illustrating a result of measurement of a desirable intensity distribution of the laser light emitted from the intensity conversion lens in the second comparative example at the position where the SLM is arranged;

FIG. 17 is a chart illustrating a result of measurement of the wavefront of the laser light emitted from the intensity conversion lens in the second comparative example at the position where the SLM is arranged;

FIG. 18 is a structural diagram illustrating the laser light shaping and wavefront controlling optical system in accordance with a second embodiment (second example);

FIG. 19 is a chart illustrating a result of measurement of a desirable intensity distribution of the laser light emitted from the intensity conversion lens in the second example at the position where the SLM is arranged;

FIG. 20 is a chart illustrating a result of measurement of the wavefront of the laser light emitted from the intensity conversion lens in the second example at the position where the SLM is arranged;

FIG. 21 is a structural diagram illustrating the laser light shaping and wavefront controlling optical system in accordance with a third embodiment (third example);

FIG. 22 is a chart illustrating a result of measurement of a desirable intensity distribution of the laser light emitted from the intensity conversion lens in the third example at the position where the SLM is arranged;

FIG. 23 is a chart illustrating a result of measurement of the wavefront of the laser light emitted from the intensity conversion lens in the third example at the position where the SLM is arranged;

FIG. 24 is a structural diagram illustrating the laser light shaping and wavefront controlling optical system in accordance with a fourth embodiment (fourth example);

FIG. 25 is a chart illustrating a result of measurement of a desirable intensity distribution of the laser light emitted from the intensity conversion lens in the fourth example at the position where the SLM is arranged;

FIG. 26 is a chart illustrating a result of measurement of the wavefront of the laser light emitted from the intensity conversion lens in the fourth example at the position where the SLM is arranged; and

FIG. 27 is a structural diagram illustrating the laser light shaping and wavefront controlling optical system in accordance with a modified example.

### DESCRIPTION OF THE PREFERRED EMBODIMENTS

In the following, preferred embodiments of the present invention will be explained in detail with reference to the drawings. In the drawings, the same or equivalent parts will be referred to with the same signs.

Before explaining the embodiments of the present invention, comparative examples of the present invention will be explained. To begin with, in a first comparative example, a mode comprising an intensity conversion lens for shaping the intensity distribution of laser light and a spatial light modulator (light modulator, hereinafter referred to as “SLM”) for controlling the waveform of the laser light is devised. That is, in a laser light shaping and wavefront controlling optical system, constituted by a homogenizer, an image-forming optical system, and an SLM in sequence, in which the image-forming optical system expands or reduces the laser light such that the laser light attains a size substantially identical to that of the modulation surface in order to enhance the modulation efficiency of the SLM, devised is one which eliminates phase correction lenses in the homogenizer, so as to perform the phase correction by using the SLM, and homogenize the intensity distribution of the laser light and expands or reduces the laser light at the same time by using the intensity conversion lens alone.

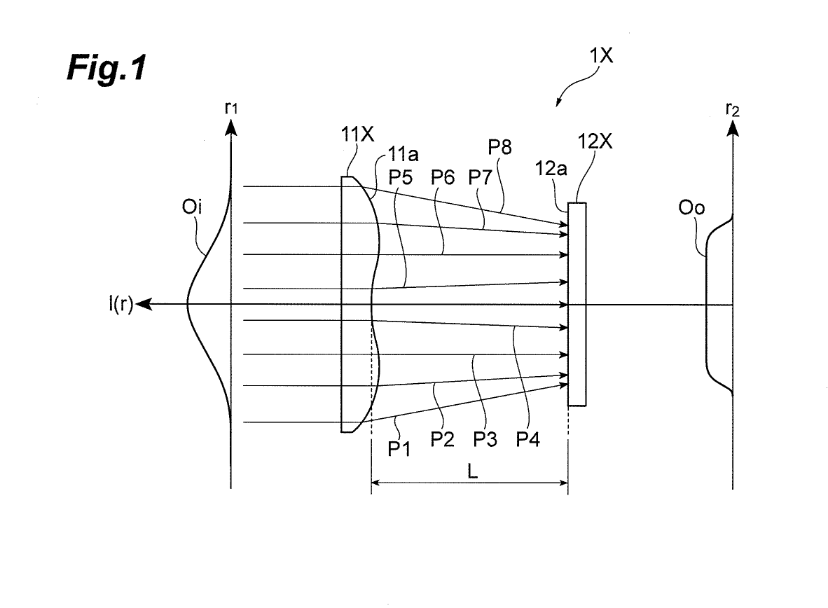

FIG. 1 is a structural diagram illustrating the laser light shaping and wavefront controlling optical system in accordance with the first comparative example of the present invention. The laser light shaping and wavefront controlling optical system 1X in accordance with the first comparative example comprises an intensity conversion lens 11X and an SLM 12X.

The intensity conversion lens 11X is used for shaping the intensity distribution of laser light into a given form and can produce output laser light Oo having a desirable intensity distribution into which the intensity distribution of input laser light Oi is shaped according to the designed form of an aspheric surface 11a.

The SLM 12X, an example of which is an LCOS-SLM (Liquid Crystal on Silicon-Spatial Light Modulator), modulates the phase of the laser light emitted from the intensity conversion lens 11X, so as to perform wavefront control. For example, a correction wavefront for correcting the spherical aberration occurring within a transparent medium is set in the case where the inside of the transparent medium is processed by the laser light converged by a condenser lens arranged in a later stage.

As with a phase correction lens in the homogenizer, the SLM 12X makes the laser light emitted from the intensity conversion lens 11X have a uniform phase, so as to be corrected to a plane wave. For example, the correction wavefront is set such as to correct the wavefront changed by the intensity conversion lens at a position where the SLM 12X is arranged.

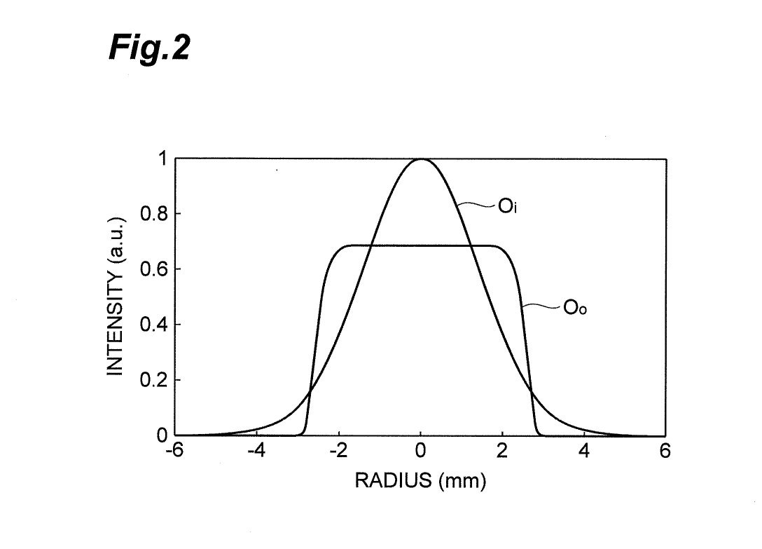

The following will illustrate an example of designing the form of the aspheric surface in the intensity conversion lens 11X. For example, the desirable intensity distribution is supposed to be set to a spatially uniform intensity distribution (Oo in FIG. 2) which is desired for laser processing apparatus, optical tweezers, high-resolution microscopes, and the like. Here, it is necessary for the desirable intensity distribution to be set such that the energy of the output laser light Oo (area of the desirable intensity distribution) equals the energy of the input laser light Oi (area of the intensity distribution). Hence, the uniform intensity distribution is set as follows, for example.

As illustrated in FIG. 2, the intensity distribution of the input laser light Oi is a concentric Gaussian distribution (wavelength: 1064 nm; beam diameter: 5.6 mm at 1/e²; ω=2.0 mm). Since the Gaussian distribution is represented by the following expression (1), the energy of the input laser light Oi within the range of a radius of 6 mm is obtained by the following expression (2):

$$\begin{matrix}[ Mathematical expression 1 ] & \\ {I}_{1} ( r ) = exp \{ - {( \frac{r}{ω} )}^{2} \} & ( 1 ) \\ [ Mathematical expression 2 ] & \\ {\int }_{- 6}^{6} {I}_{1} ( r ) d r = 1.76689 & ( 2 )\end{matrix}$$

In this case, the Gaussian distribution is rotationally symmetric about a radius of 0 mm, whereby the aspheric surface form is designed by one-dimensional analysis.

On the other hand, the desirable intensity distribution of the output laser light Oo is set to a uniform intensity distribution (order N=8; ω=2.65 mm) as illustrated in FIG. 2. Since the uniform intensity distribution is represented by the following expression (3), the value of the uniform intensity part of the output laser light Oo is set as E₀=0.687 in order for the energy within the radius of 6 mm of the output laser light Oo to equal the energy of the input laser light Oi as in the following expression (4):

$$\begin{matrix}[ Mathematical expression 3 ] & \\ {I}_{2} ( r ) = {E}_{0} \times exp \{ - {( \frac{r}{ω} )}^{2 N} \} & ( 3 ) \\ [ Mathematical expression 4 ] & \\ {\int }_{- 6}^{6} {I}_{1} ( r ) d r = {\int }_{- 6}^{6} {I}_{2} ( r ) d r & ( 4 )\end{matrix}$$

According to this technique, the desirable intensity distribution of the shaped output laser light can not only follow a specified function, but also become a given intensity distribution.

Subsequently, as illustrated in FIG. 1, optical paths P1 to P8 which are optical paths from the aspheric surface 11a of the intensity conversion lens 11X to the modulation surface 12a of the SLM 12X at given coordinates in the radial direction of the aspherical lens 11X are determined such that the intensity distribution of the input laser light Oi at the intensity conversion lens 11X becomes the desirable intensity distribution of the output laser light Oo at the SLM 12X, i.e., such that light having a stronger intensity near the center in the input laser light Oi diffuses to peripheral parts, while light having a weaker intensity in the peripheral parts converges.

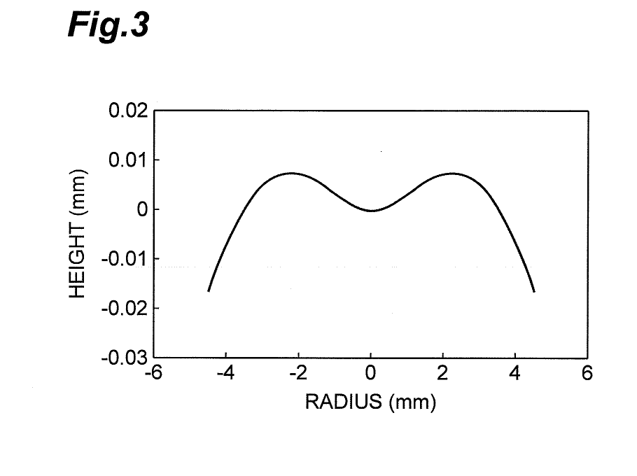

Thereafter, according to thus determined optical paths P1 to P8, the form of the aspheric surface 11a of the intensity conversion lens 11X is determined. Specifically, with reference to the center of the intensity conversion lens 11X, the difference in height of the aspheric surface 11a is determined at each coordinate in the radial direction r₁ so as to yield the optical paths P1 to P8. Then, the form of the aspheric surface 11a of the intensity conversion lens 11X is determined as illustrated in FIG. 3.

FIG. 3 is an example of designing in which CaF₂ (n=1.42) is used as a material for the aspherical lens 11X, while the distance between the center position (where coordinate r₁=0) of the aspheric surface 11a and the modulation surface 12a of the SLM 12X is set as L=165 mm.

According to the idea of the inventors, when the expansion or reduction of the beam diameter of the laser light is also taken into consideration in the above-mentioned designing of the form of the aspheric surface, the intensity conversion lens 11X by itself can shape the intensity distribution of the input laser light Oi into a desirable intensity distribution and produce the output laser light Oo having expanded or reduced its beam diameter to a desirable size.

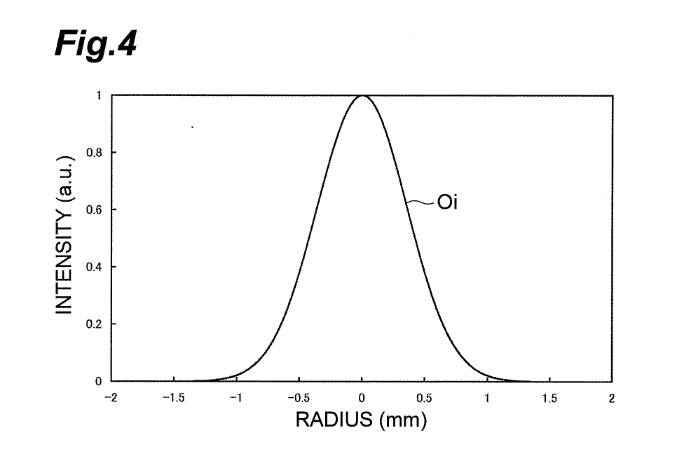

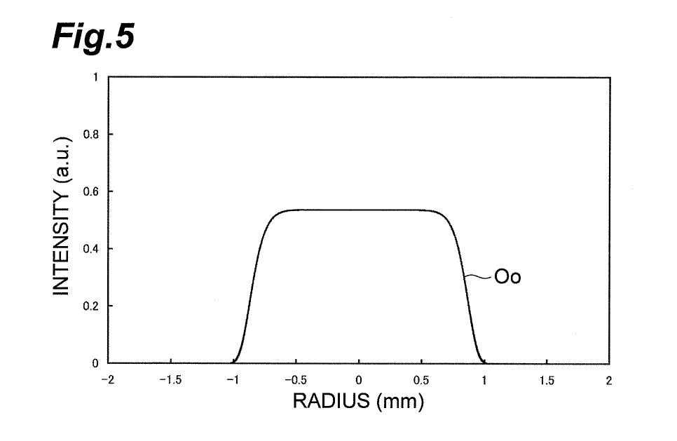

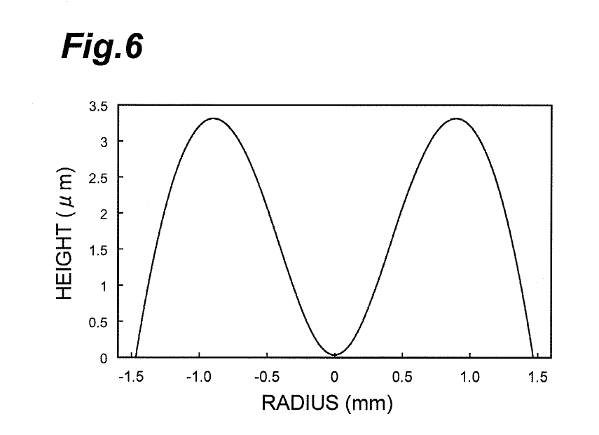

For example, suppose that the input laser light Oi having an intensity distribution which is a concentric Gaussian distribution (with a wavelength of 1064 nm and a beam diameter of 1.44 mm at 1/e²) as illustrated in FIG. 4 is shaped into a uniform intensity distribution (with an order of 6 and a beam diameter of 2.482 mm at 1/e²) as illustrated in FIG. 5, while generating output laser light Oo with an expanded beam diameter. In this case, according to the form design of the aspheric surface mentioned above, the form of the aspheric surface 11a of the intensity conversion lens 11X is determined as illustrated in FIG. 6.

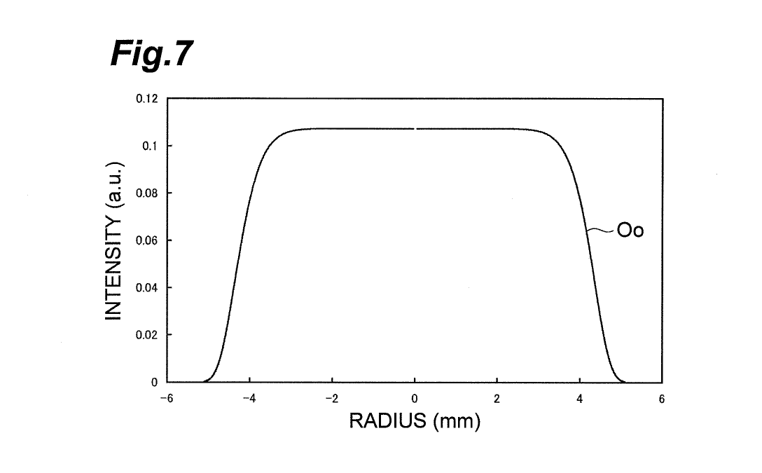

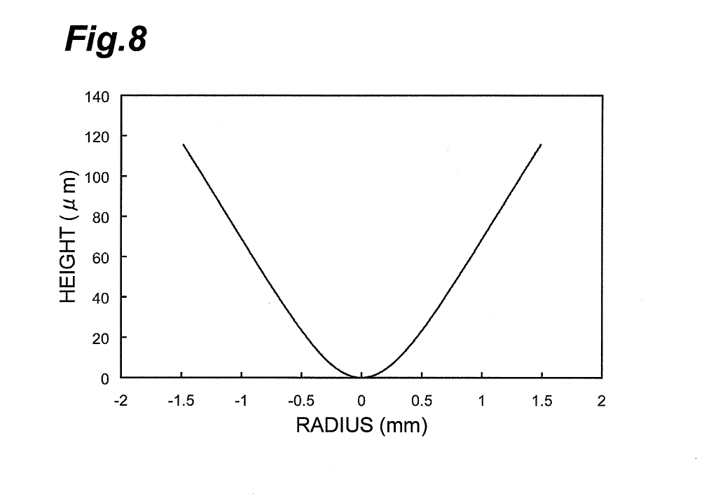

For example, suppose that the input laser light Oi having an intensity distribution which is the concentric Gaussian distribution illustrated in FIG. 4 is shaped into a uniform intensity distribution (with an order of 6 and a beam diameter of 12.41 mm at 1/e²) as illustrated in FIG. 7, while generating output laser light Oo with a further expanded beam diameter. In this case, according to the form design of the aspheric surface mentioned above, the form of the aspheric surface 11a of the intensity conversion lens 11X is determined as illustrated in FIG. 8.

FIGS. 6 and 8 are examples of design using MgF₂ (n=1.377) as a material for the aspherical lens 11X and setting the distance between the center position (where coordinate r₁=0) of the aspheric surface and the modulation surface 12a of the SLM 12X as L=100 mm.

For clarifying how the difference in height varies between the aspheric surfaces, the origin (the position where the height is 0 μm) of the ordinates differs from the center (where coordinate r₁=0) of the aspherical lens 11X in FIGS. 6 and 8.

According to FIGS. 6 and 8, expanding the beam diameter by 12.41/2.482=5 times increases the amount of processing the intensity conversion lens 11X by about 34 times in terms of volume ratio. Thus, when the magnifying or reducing power of the intensity conversion lens is set greater, i.e., when trying to homogenize the intensity distribution of the laser light and expand or reduce the laser light at the same time by the intensity conversion lens alone, the intensity conversion lens increases its area and the difference in height of its aspheric surface, whereby the amount of processing the aspheric surface of the intensity conversion lens becomes greater. This prolongs the processing time required for making the intensity conversion lens, thereby increasing the manufacturing cost.

When trying to homogenize the intensity distribution of the laser light and expand or reduce the laser light at the same time by the intensity conversion lens alone, the ratio of the component for homogenizing the intensity distribution decreases as compared with the component for expanding or reducing the beam diameter, so that the action of expanding or reducing the beam diameter may become dominant depending on the magnifying or reducing power, whereby the action of homogenizing the intensity distribution may not fully be obtained.

Therefore, in a laser light shaping and wavefront controlling optical system which shapes an intensity distribution of laser light into a given intensity distribution and controls the wavefront of the laser light at the same time, the inventors devise one which inhibits the processing time for optical lenses from being prolonged by expanding or reducing the laser light.

### First Embodiment

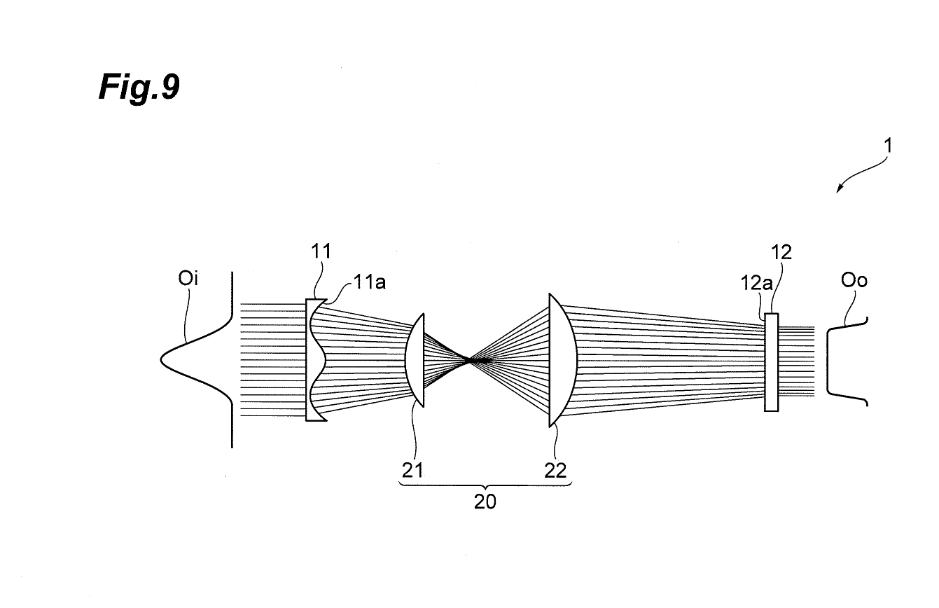

FIG. 9 is a structural diagram illustrating the laser light shaping and wavefront controlling optical system in accordance with the first embodiment of the present invention. This laser light shaping and wavefront controlling optical system 1 in accordance with the first embodiment comprises an intensity conversion lens 11, an SLM 12, and an expansion optical system 20 disposed between the intensity conversion lens 11 and the SLM 12.

As with the above-mentioned intensity conversion lens 11X, the intensity conversion lens 11 is used for shaping an intensity distribution of laser light into a given form and can produce output laser light Oo having a desirable intensity distribution into which the intensity distribution of input laser light Oi is shaped according to the designed form of the aspheric surface 11a.

As with the above-mentioned SLM 12X, the SLM 12 is an LCOS-SLM (Liquid Crystal on Silicon-Spatial Light Modulator), for example, and modulates the phase of the laser light emitted from the intensity conversion lens 11, so as to perform wavefront control. More specifically, the SLM 12 modulates the phase of the laser light whose beam diameter is expanded by the expansion optical system 20, which will be explained later, after its intensity distribution is shaped by the intensity conversion lens 11. For example, a correction wavefront for correcting the spherical aberration occurring within a transparent medium is set in the case where the inside of the transparent medium is processed by the laser light converged by a condenser lens arranged in a later stage.

As with the above-mentioned SLM 12X, the SLM 12 makes the laser light emitted from the intensity conversion lens 11 have a uniform phase, so as to be corrected to a plane wave. For example, the correction wavefront is set such as to correct the wavefront changed by the intensity conversion lens at a position where the SLM 12 is arranged. The expansion optical system 20 is placed between the intensity conversion lens 11 and the SLM 12.

The expansion optical system 20 is used for expanding the beam diameter of the laser light emitted from the intensity conversion lens 11 and comprises a pair of convex lenses 21, 22. The convex lens 21 is arranged on the intensity conversion lens 11 side and has a convex entrance surface and a planar exit surface. On the other hand, the convex lens 22 is arranged on the SLM 12 side and has a planar entrance surface and a convex exit surface. A converging point exists between the pair of convex lenses 21, 22 in the expansion optical system 20. According to the respective focal lengths of the pair of convex lenses 21, 22, the expansion optical system 20 can expand the beam diameter of the laser light emitted from the intensity conversion lens 11 into a given size.

In the laser light shaping and wavefront controlling optical system 1 in accordance with the first embodiment, the expansion optical system 20 arranged between the intensity conversion lens 11 and the SLM 12 expands the laser light, whereby it is sufficient for the intensity conversion lens 11 to shape the intensity distribution of the laser light. This can inhibit the intensity conversion lens 11 from increasing the difference in height of its aspheric surface and prolonging its processing time.

### First Example

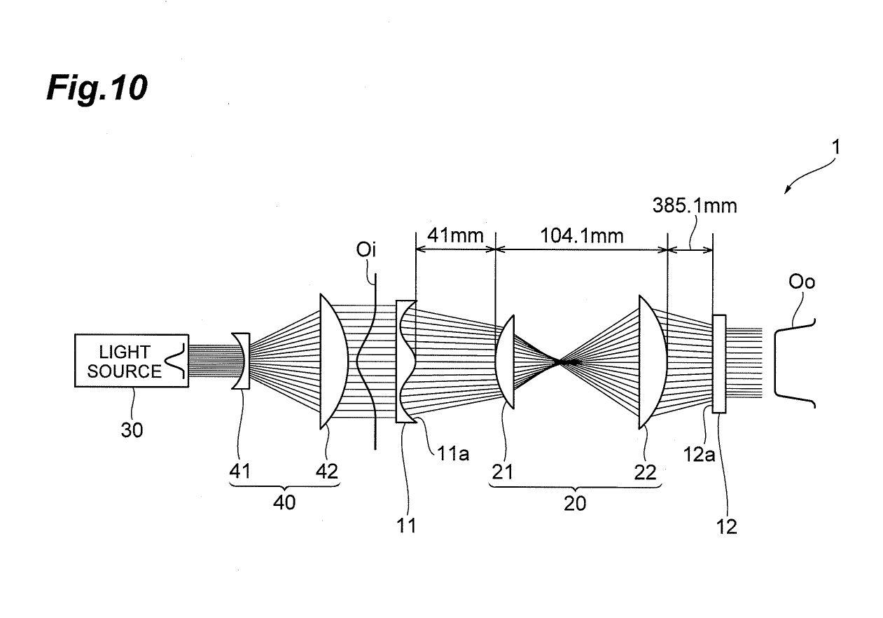

The laser light shaping and wavefront controlling optical system 1 in accordance with the first embodiment was designed as a first example. In the first example, as illustrated in FIG. 10, the laser light generated by a laser light source 30 was supposed to be expanded by an expander 40 and then made incident on the laser light shaping and wavefront controlling optical system 1.

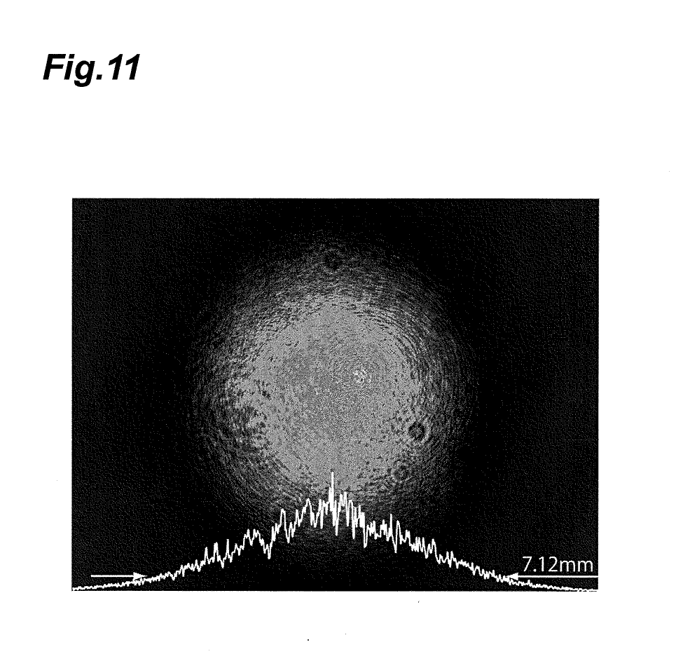

A fiber laser having a wavelength of 1064 nm was used as the laser light source 30, while employed as the expander 40 was one constituted by a pair of concave and convex lenses 41, 42. In this example, laser light Oi having expanded the laser light from the laser light source 30 to a diameter of 7.12 mm as illustrated in FIG. 11 was produced by the expander 40. According to FIG. 11, the intensity distribution of the laser light Oi incident on the laser light shaping and wavefront controlling optical system 1 was a concentric Gaussian distribution.

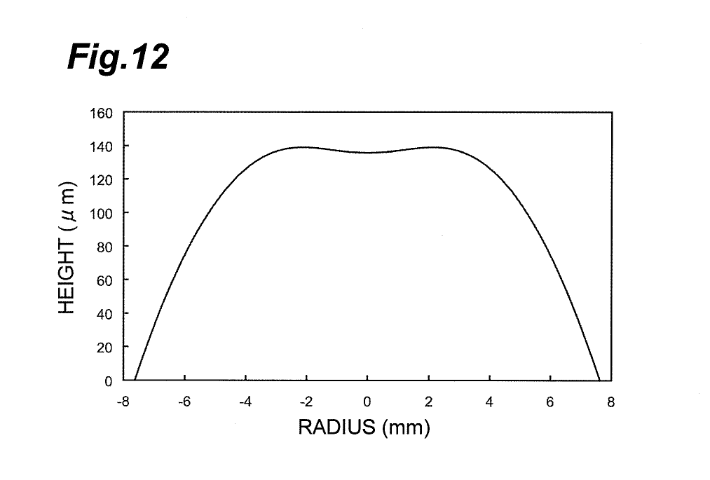

Then, as in the form design of the aspheric surface mentioned above, the form of the aspheric surface 11a of the intensity conversion lens 11 was determined as illustrated in FIG. 12. Here, the design was made while using MgF₂ (n=1.377) as a material for the aspherical lens 11, setting the distance between the center position of the aspheric surface and the modulation surface 12a in the state without the expansion optical system 20 as L=215 mm, and taking account of the change in the optical path caused by inserting the expansion optical system 20 therein. For clarifying how the difference in height of the aspheric surface varies, the origin (the position where the height is 0 μm) of the ordinate in FIG. 12 differs from the center (where the radius is 0 mm) of the aspherical lens 11.

Employed in the expansion optical system 20 were a condenser lens 21 made of BK7 having a thickness of 4.6 mm and a focal length of 41 mm and a condenser lens 22 made of BK7 having a thickness of 3.6 mm and a focal length of 61.5 mm.

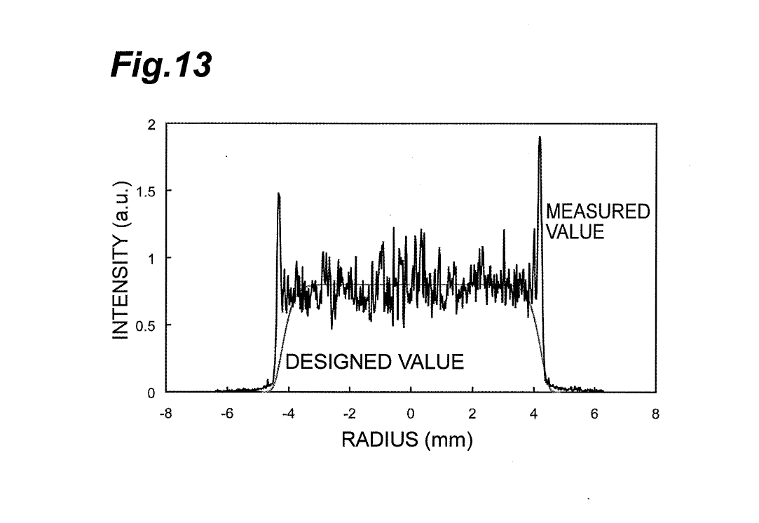

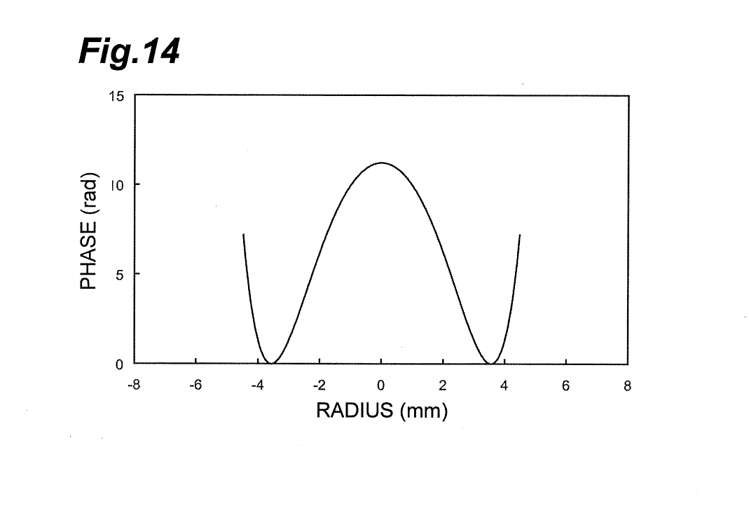

Then, as illustrated in FIG. 13, a desirable intensity distribution was obtained at 530 mm from the intensity conversion lens 11. A wavefront represented by FIG. 14 was also obtained at 530 mm from the intensity conversion lens 11. It was sufficient for the SLM 12 to set a correction wavefront such as to correct the wavefront mentioned above.

### Second Comparative Example

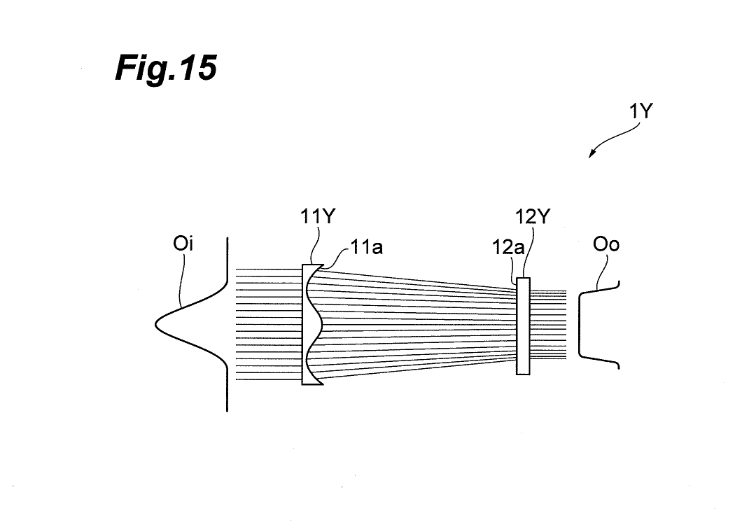

A laser light shaping and wavefront controlling optical system 1Y illustrated in FIG. 15 was designed as a second comparative example. The laser light shaping and wavefront controlling optical system 1Y in accordance with the second comparative example was different from that of the first example in that it lacked the expansion optical system 20 of the laser light shaping and wavefront controlling optical system 1.

The laser light generated by the laser light source 30 was supposed to be expanded by the expander 40 and then made incident on the laser light shaping and wavefront controlling optical system 1Y in the second comparative example as well. Therefore, the form of the aspheric surface 11a of the intensity conversion lens 11Y was the same as that of the aspheric surface 11a of the intensity conversion lens 11.

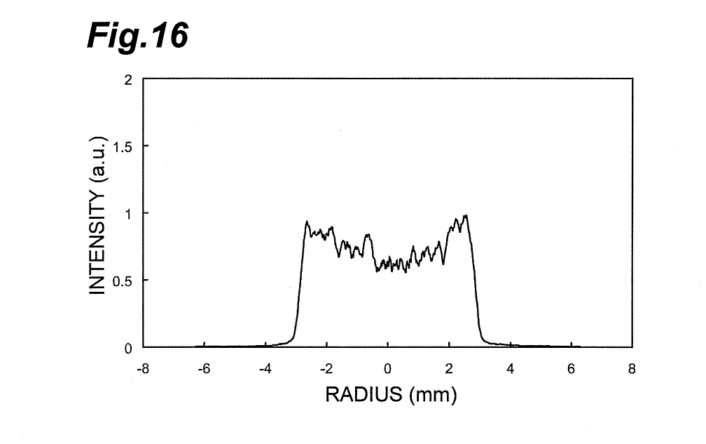

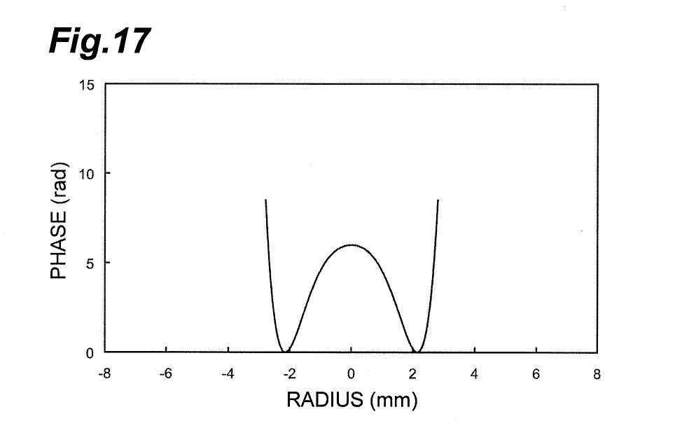

Then, as illustrated in FIG. 16, a desirable intensity distribution was obtained at 215 mm from the intensity conversion lens 11Y. A wavefront represented by FIG. 17 was also obtained at 215 mm from the intensity conversion lens 11Y. It was sufficient for the SLM 12 to set a correction wavefront such as to correct the wavefront mentioned above.

### [Comparative Validation]

When the intensity distributions (FIGS. 13 and 16) and wavefronts (FIGS. 14 and 17) in SLMs 12, 12Y were compared with each other, it was found that the first example was able to expand the laser light by about 61.5/41=1.5 times, which corresponded to the magnifying power of the expansion optical system 20, by placing the expansion optical system 20 between the intensity conversion lens 11 and the SLM 12.

For expanding the laser light as such, no needs were seen for changing the form of the aspheric surface 11a of the intensity conversion lens 11 and increasing the area and difference in height of the aspheric surface 11a (FIG. 15). Hence, the first example can inhibit the processing time for the intensity conversion lens 11 from increasing.

### Second Embodiment

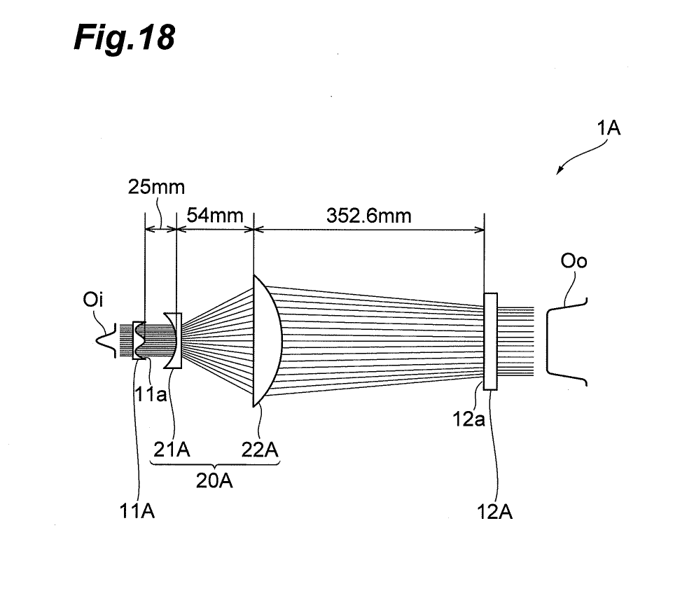

FIG. 18 is a structural diagram illustrating the laser light shaping and wavefront controlling optical system in accordance with the second embodiment of the present invention. This laser light shaping and wavefront controlling optical system 1A in accordance with the second embodiment comprises an intensity conversion lens 11A, an SLM 12A, and an expansion optical system 20A disposed between the intensity conversion lens 11A and the SLM 12A.

As with the above-mentioned intensity conversion lens 11, the intensity conversion lens 11A is used for shaping an intensity distribution of laser light into a given form and can produce output laser light Oo having a desirable intensity distribution into which the intensity distribution of input laser light Oi is shaped according to the designed form of the aspheric surface 11a.

As with the above-mentioned SLM 12, the SLM 12A is an LCOS-SLM (Liquid Crystal on Silicon-Spatial Light Modulator), for example, and modulates the phase of the laser light emitted from the intensity conversion lens 11A, so as to perform wavefront control. More specifically, the SLM 12A modulates the phase of the laser light whose beam diameter is expanded by the expansion optical system 20A, which will be explained later, after its intensity distribution is shaped by the intensity conversion lens 11A. For example, a correction wavefront for correcting the spherical aberration occurring within a transparent medium is set in the case where the inside of the transparent medium is processed by the laser light converged by a condenser lens arranged in a later stage.

As with the above-mentioned SLM 12, the SLM 12A makes the laser light emitted from the intensity conversion lens 11A have a uniform phase, so as to be corrected to a plane wave. For example, the correction wavefront is set such as to correct the wavefront changed by the intensity conversion lens at a position where the SLM 12A is arranged. The expansion optical system 20A is placed between the intensity conversion lens 11A and the SLM 12A.

The expansion optical system 20A is used for expanding the beam diameter of the laser light emitted from the intensity conversion lens 11A and comprises a pair of concave and convex lenses 21A, 22A. The concave lens 21A is arranged on the intensity conversion lens 11A side and has a concave entrance surface and a planar exit surface. On the other hand, the convex lens 22A is arranged on the SLM 12A side and has a planar entrance surface and a convex exit surface. No converging point exists between the pair of concave and convex lenses 21A, 22A in the expansion optical system 20A. According to the respective focal lengths of the pair of concave and convex lenses 21A, 22A, the expansion optical system 20A can expand the beam diameter of the laser light emitted from the intensity conversion lens 11A into a given size.

The laser light shaping and wavefront controlling optical system 1A in accordance with the second embodiment can also yield advantages similar to those of the laser light shaping and wavefront controlling optical system 1 in accordance with the first embodiment.

When practical use is taken into consideration, however, the expansion optical system 20 in the first embodiment once converges (crosses) a beam and then expands it, which increases the optical path length and may cause air breakdown at the converging point (cross point). In terms of optical design, on the other hand, another optical element (such as a reflector for monitoring) cannot be arranged within the expansion optical system even when required, since the light intensity is so strong near the converging point that the optical element may be damaged.

Since the expansion optical system 20A is constituted by the concave and convex lenses 21A, 22A, by contrast, no converging point (cross point) exists in the laser light shaping and wavefront controlling optical system 1A in accordance with the second embodiment. This can reduce the optical path length while preventing air breakdown from occurring at the converging point. Also, optical elements arranged within the expansion optical system, if any, are not damaged, which is advantageous in that the degree of freedom in optical design is high, whereby further smaller sizes can be achieved.

### Second Example

The laser light shaping and wavefront controlling optical system 1A in accordance with the second embodiment was designed as a second example. In the second example, as in FIG. 10, the laser light generated by the laser light source 30 was supposed to be expanded by the expander 40 and then made incident on the laser light shaping and wavefront controlling optical system 1A. Therefore, the form of the aspheric surface 11a of the intensity conversion lens 11A is the same as that of the aspheric surface 11a of the intensity conversion lens 11 (FIG. 15).

Employed in the expansion optical system 20A were a diffusing lens 21A made of BK7 having a thickness of 2 mm and a focal length of 102.4 mm and a condenser lens 22A made of BK7 having a thickness of 3 mm and a focal length of 153.7 mm.

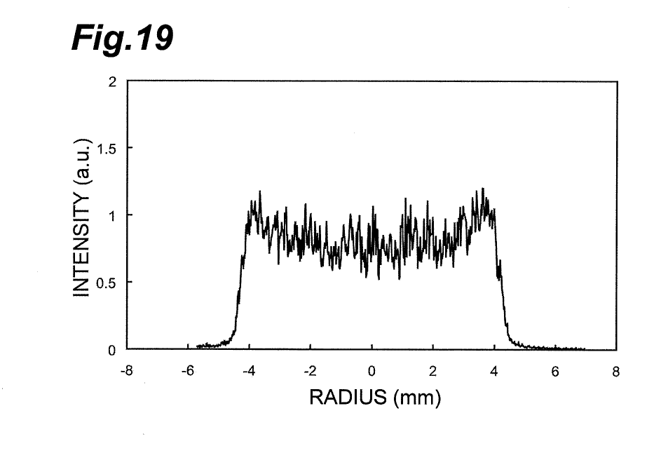

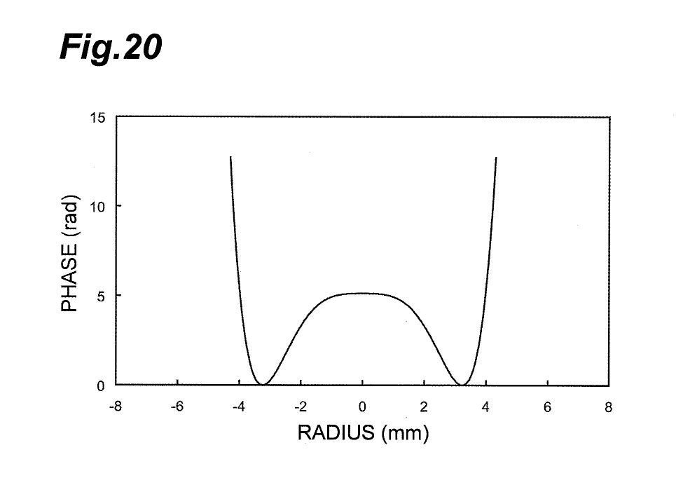

Then, as illustrated in FIG. 19, a desirable intensity distribution was obtained at 431.6 mm from the intensity conversion lens 11A. A wavefront represented by FIG. 20 was also obtained at 431.6 mm from the intensity conversion lens 11A. It was sufficient for the SLM 12A to set a correction wavefront such as to correct the wavefront mentioned above.

The second example was also able to expand the laser light by about 61.5/41=1.5 times, which corresponded to the magnifying power of the expansion optical system 20A, by placing the expansion optical system 20A between the intensity conversion lens 11A and the SLM 12A.

For expanding the laser light as such, no needs were seen for changing the form of the aspheric surface 11a of the intensity conversion lens 11A and increasing the area and difference in height of the aspheric surface 11a. Hence, this can inhibit the processing time for the intensity conversion lens 11A from increasing.

While the first example obtained a uniform intensity distribution at 530 mm from the intensity conversion lens 11, the second example was able to yield a uniform intensity distribution at 431.6 mm from the intensity conversion lens 11A. That is, the second example was seen to be able to reduce the optical path length.

### Third Embodiment

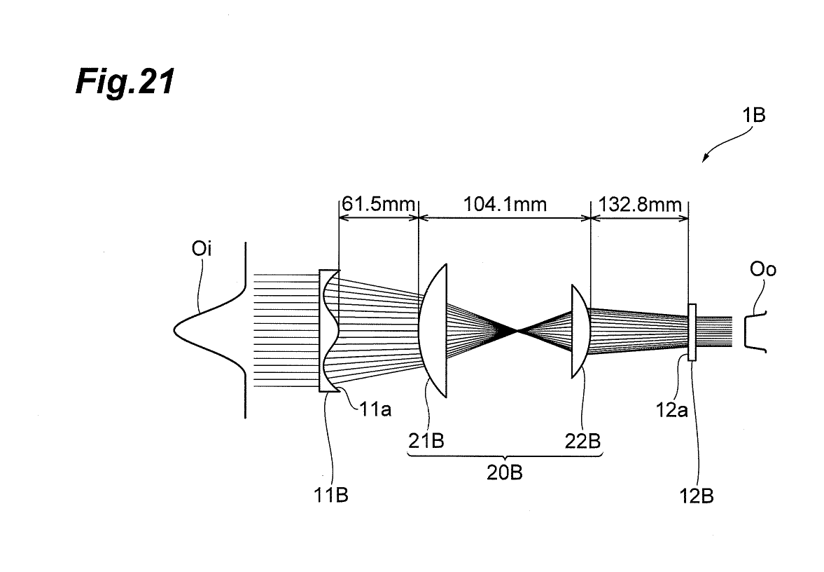

FIG. 21 is a structural diagram illustrating the laser light shaping and wavefront controlling optical system in accordance with the third embodiment of the present invention. This laser light shaping and wavefront controlling optical system 1B in accordance with the third embodiment comprises an intensity conversion lens 11B, an SLM 12B, and a reduction optical system 20B disposed between the intensity conversion lens 11B and the SLM 12B.

As with the above-mentioned intensity conversion lens 11, the intensity conversion lens 11B is used for shaping an intensity distribution of laser light into a given form and can produce output laser light Oo having a desirable intensity distribution into which the intensity distribution of input laser light Oi is shaped according to the designed form of the aspheric surface 11a.

As with the above-mentioned SLM 12, the SLM 12B is an LCOS-SLM (Liquid Crystal on Silicon-Spatial Light Modulator), for example, and modulates the phase of the laser light emitted from the intensity conversion lens 11B, so as to perform wavefront control. More specifically, the SLM 12B modulates the phase of the laser light whose beam diameter is reduced by the reduction optical system 20B, which will be explained later, after its intensity distribution is shaped by the intensity conversion lens 11B. For example, a correction wavefront for correcting the spherical aberration occurring within a transparent medium is set in the case where the inside of the transparent medium is processed by the laser light converged by a condenser lens arranged in a later stage.

As with the above-mentioned SLM 12, the SLM 12B makes the laser light emitted from the intensity conversion lens 11B have a uniform phase, so as to be corrected to a plane wave. For example, the correction wavefront is set such as to correct the wavefront changed by the intensity conversion lens at a position where the SLM 12B is arranged. The reduction optical system 20B is placed between the intensity conversion lens 11B and the SLM 12B.

The reduction optical system 20B is used for reducing the beam diameter of the laser light emitted from the intensity conversion lens 11B and comprises a pair of convex lenses 21B, 22B. The convex lens 21B is arranged on the intensity conversion lens 11B side and has a convex entrance surface and a planar exit surface. On the other hand, the convex lens 22B is arranged on the SLM 12 side and has a planar entrance surface and a convex exit surface. A converging point exists between the pair of convex lenses 21B, 22B in the reduction optical system 20B. According to the respective focal lengths of the pair of convex lenses 21B, 22B, the reduction optical system 20B can reduce the beam diameter of the laser light emitted from the intensity conversion lens 11B into a given size.

In the laser light shaping and wavefront controlling optical system 1B in accordance with the third embodiment, the reduction optical system 20B arranged between the intensity conversion lens 11B and the SLM 12B reduces the laser light, whereby it is sufficient for the intensity conversion lens 11B to shape the intensity distribution of the laser light. This can inhibit the intensity conversion lens 11B from increasing the difference in height of its aspheric surface and prolonging its processing time.

### Third Example

The laser light shaping and wavefront controlling optical system 1B in accordance with the third embodiment was designed as a third example. In the third example, as in FIG. 10, the laser light generated by the laser light source 30 was supposed to be expanded by the expander 40 and then made incident on the laser light shaping and wavefront controlling optical system 1B. Therefore, the form of the aspheric surface 11a of the intensity conversion lens 11B is the same as that of the aspheric surface 11a of the intensity conversion lens 11 (FIG. 15).

Employed in the reduction optical system 20B were a condenser lens 21B made of BK7 having a thickness of 3.6 mm and a focal length of 61.5 mm and a condenser lens 22B made of BK7 having a thickness of 4.6 mm and a focal length of 41 mm.

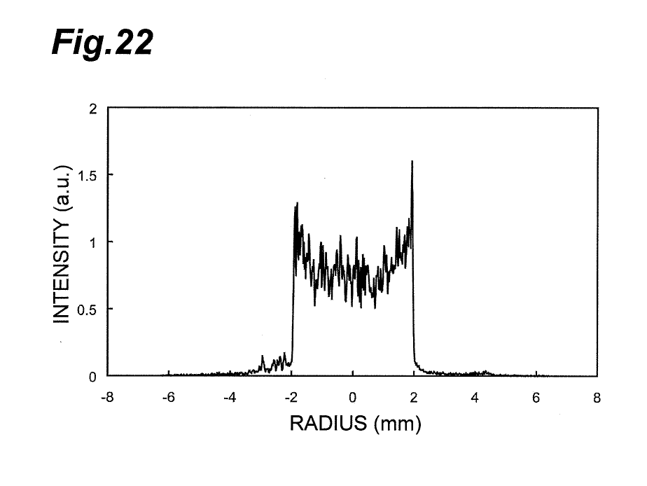

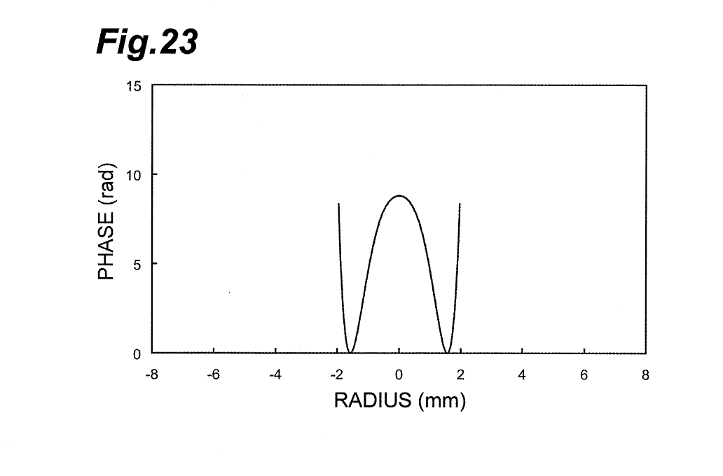

Then, as illustrated in FIG. 22, a desirable intensity distribution was obtained at 530 mm from the intensity conversion lens 11B. A wavefront represented by FIG. 23 was also obtained at 530 mm from the intensity conversion lens 11B. It was sufficient for the SLM 12B to set a correction wavefront such as to correct the wavefront mentioned above.

The third example was also able to reduce the laser light by about 41/61.5=2/3, which corresponded to the reducing power of the reduction optical system 20B, by placing the reduction optical system 20B between the intensity conversion lens 11B and the SLM 12B.

For reducing the laser light as such, no needs were seen for changing the form of the aspheric surface 11a of the intensity conversion lens 11B and increasing the area and difference in height of the aspheric surface 11a. Hence, this can inhibit the processing time for the intensity conversion lens 11B from increasing.

### Fourth Embodiment

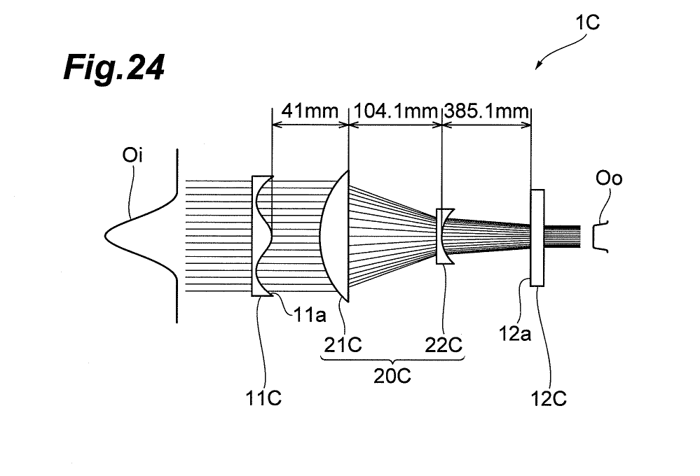

FIG. 24 is a structural diagram illustrating the laser light shaping and wavefront controlling optical system in accordance with the fourth embodiment of the present invention. This laser light shaping and wavefront controlling optical system 1C in accordance with the fourth embodiment comprises an intensity conversion lens 11C, an SLM 12C, and a reduction optical system 20C disposed between the intensity conversion lens 11C and the SLM 12C.

As with the above-mentioned intensity conversion lens 11, the intensity conversion lens 11C is used for shaping an intensity distribution of laser light into a given form and can produce output laser light Oo having a desirable intensity distribution into which the intensity distribution of input laser light Oi is shaped according to the designed form of the aspheric surface 11a.

As with the above-mentioned SLM 12, the SLM 12C is an LCOS-SLM (Liquid Crystal on Silicon-Spatial Light Modulator), for example, and modulates the phase of the laser light emitted from the intensity conversion lens 11C, so as to perform wavefront control.

More specifically, the SLM 12C modulates the phase of the laser light whose beam diameter is reduced by the reduction optical system 20C, which will be explained later, after its intensity distribution is shaped by the intensity conversion lens 11C. For example, a correction wavefront for correcting the spherical aberration occurring within a transparent medium is set in the case where the inside of the transparent medium is processed by the laser light converged by a condenser lens arranged in a later stage.

As with the above-mentioned SLM 12, the SLM 12C makes the laser light emitted from the intensity conversion lens 11C have a uniform phase, so as to be corrected to a plane wave. For example, the correction wavefront is set such as to correct the wavefront changed by the intensity conversion lens at a position where the SLM 12C is arranged. The reduction optical system 20C is placed between the intensity conversion lens 11C and the SLM 12C.

The reduction optical system 20C is used for reducing the beam diameter of the laser light emitted from the intensity conversion lens 11C and comprises a pair of convex and concave lenses 21C, 22C. The convex lens 21C is arranged on the intensity conversion lens 11C side and has a convex entrance surface and a planar exit surface. On the other hand, the concave lens 22C is arranged on the SLM 12C side and has a planar entrance surface and a concave exit surface. No converging point exists between the pair of convex and concave lenses 21C, 22C in the reduction optical system 20C. According to the respective focal lengths of the pair of convex and concave lenses 21C, 22C, the reduction optical system 20C can reduce the beam diameter of the laser light emitted from the intensity conversion lens 11C into a given size.

The laser light shaping and wavefront controlling optical system 1C in accordance with the fourth embodiment can yield advantages similar to those of the laser light shaping and wavefront controlling optical system 1B in accordance with the third embodiment.

Since the reduction optical system 20C is constituted by the convex and concave lenses 21C, 22C, no converging point (cross point) exists in the laser light shaping and wavefront controlling optical system 1C in accordance with the fourth embodiment as in the laser light shaping and wavefront controlling optical system 1A in accordance with the second embodiment. This can reduce the optical path length while preventing air breakdown from occurring at the converging point. Also, optical elements arranged within the expansion optical system, if any, are not damaged, which is advantageous in that the degree of freedom in optical design is high, whereby further smaller sizes can be achieved.

### Fourth Example

The laser light shaping and wavefront controlling optical system 1C in accordance with the fourth embodiment was designed as a fourth example. In the fourth example, as in FIG. 10, the laser light generated by the laser light source 30 was supposed to be expanded by the expander 40 and then made incident on the laser light shaping and wavefront controlling optical system 1C. Therefore, the form of the aspheric surface 11a of the intensity conversion lens 11C is the same as that of the aspheric surface 11a of the intensity conversion lens 11 (FIG. 15).

Employed in the reduction optical system 20C were a condenser lens 21C made of BK7 having a thickness of 3 mm and a focal length of 153.7 mm and a diffusing lens 22C made of BK7 having a thickness of 2 mm and a focal length of 102.4 mm.

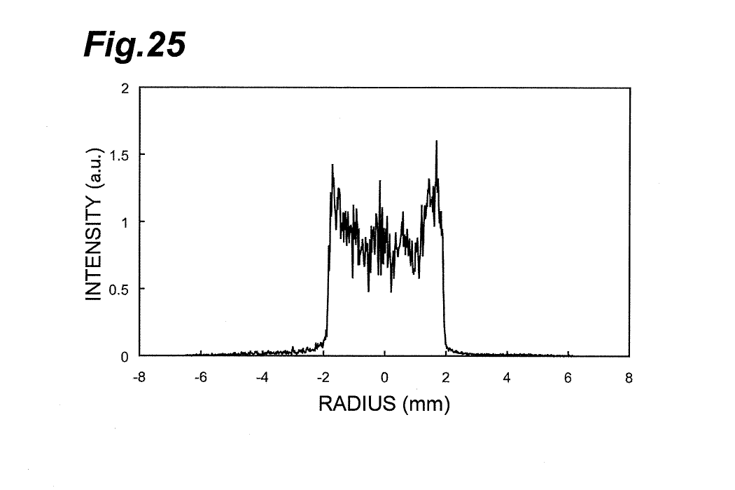

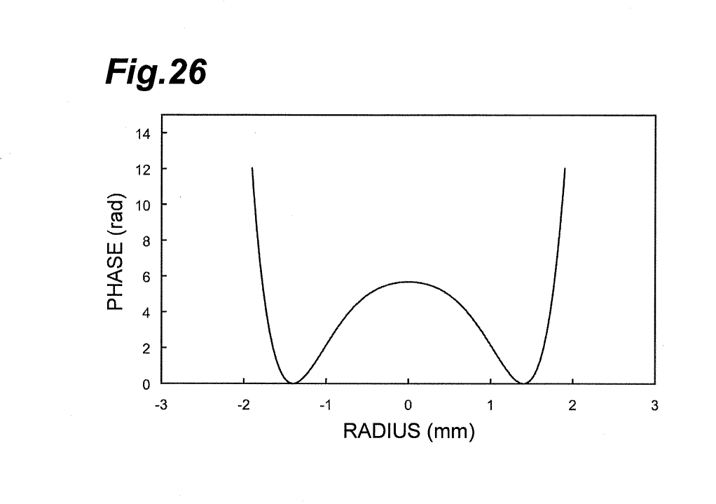

Then, as illustrated in FIG. 25, a desirable intensity distribution was obtained at 431.6 mm from the intensity conversion lens 11C. A wavefront represented by FIG. 26 was also obtained at 431.6 mm from the intensity conversion lens 11C. It was sufficient for the SLM 12C to set a correction wavefront such as to correct the wavefront mentioned above.

The fourth example was also able to reduce the laser light by about 41/61.5=2/3, which corresponded to the reducing power of the reduction optical system 20C, by placing the reduction optical system 20C between the intensity conversion lens 11C and the SLM 12C.

For reducing the laser light as such, no needs were seen for changing the form of the aspheric surface 11a of the intensity conversion lens 11C and increasing the area and difference in height of the aspheric surface 11a. Hence, this can inhibit the processing time for the intensity conversion lens 11C from increasing.

While the third example obtained a uniform intensity distribution at 530 mm from the intensity conversion lens 11B, the fourth example was able to yield a uniform intensity distribution at 431.6 mm from the intensity conversion lens 11C. That is, the fourth example was seen to be able to reduce the optical path length.

The present invention can be modified in various ways without being restricted to the above-mentioned embodiments. For example, while the modulation surface of the SLM is arranged such as to be located at a plane where the laser light emitted from the intensity conversion lens has a desirable intensity distribution, it is not necessary for the modulation surface of the light modulator to strictly coincide with a plane where the laser light emitted from the intensity conversion lens has the desirable intensity distribution. This is because the intensity distribution shaped by the intensity conversion lens does not drastically change even when deviated from its designed value.

By adjusting the position of the expansion optical system or reduction optical system, the above-mentioned embodiments can set a given position as one where the laser light emitted from the intensity conversion lens has a desirable intensity distribution.

For example, when the diffusing lens 21A (made of BK7 having a thickness of 2 mm and a focal length of 102.4 mm) in the expansion optical system 20A is positioned at 5 mm from the intensity conversion lens 11A in the second example, the position where the laser light emitted from the intensity conversion lens 11A has a desirable intensity distribution is located at 441.3 mm from the intensity conversion lens 11A. When the diffusing lens 21A is positioned at 45 mm from the intensity conversion lens 11A, the position where the laser light emitted from the intensity conversion lens 11A has a desirable intensity distribution is located at 421.9 mm from the intensity conversion lens 11A. When the diffusing lens 21A is positioned at 65 mm from the intensity conversion lens 11A, the position where the laser light emitted from the intensity conversion lens 11A has a desirable intensity distribution is located at 412.3 mm from the intensity conversion lens 11A. When the diffusing lens 21A is positioned at 85 mm from the intensity conversion lens 11A, the position where the laser light emitted from the intensity conversion lens 11A has a desirable intensity distribution is located at 402.6 mm from the intensity conversion lens 11A. When the diffusing lens 21A is positioned at 105 mm from the intensity conversion lens 11A, the position where the laser light emitted from the intensity conversion lens 11A has a desirable intensity distribution is located at 393 mm from the intensity conversion lens 11A. When the diffusing lens 21A is positioned at 125 mm from the intensity conversion lens 11A, the position where the laser light emitted from the intensity conversion lens 11A has a desirable intensity distribution is located at 383.3 mm from the intensity conversion lens 11A. When the diffusing lens 21A is positioned at 145 mm from the intensity conversion lens 11A, the position where the laser light emitted from the intensity conversion lens 11A has a desirable intensity distribution is located at 373.3 mm from the intensity conversion lens 11A.

In the above-mentioned embodiments, the correction wavefront of the SLM may be set or adjusted such as to yield a desirable wavefront at a pupil plane of a condenser lens arranged in a stage later than the laser light shaping and wavefront controlling optical system.

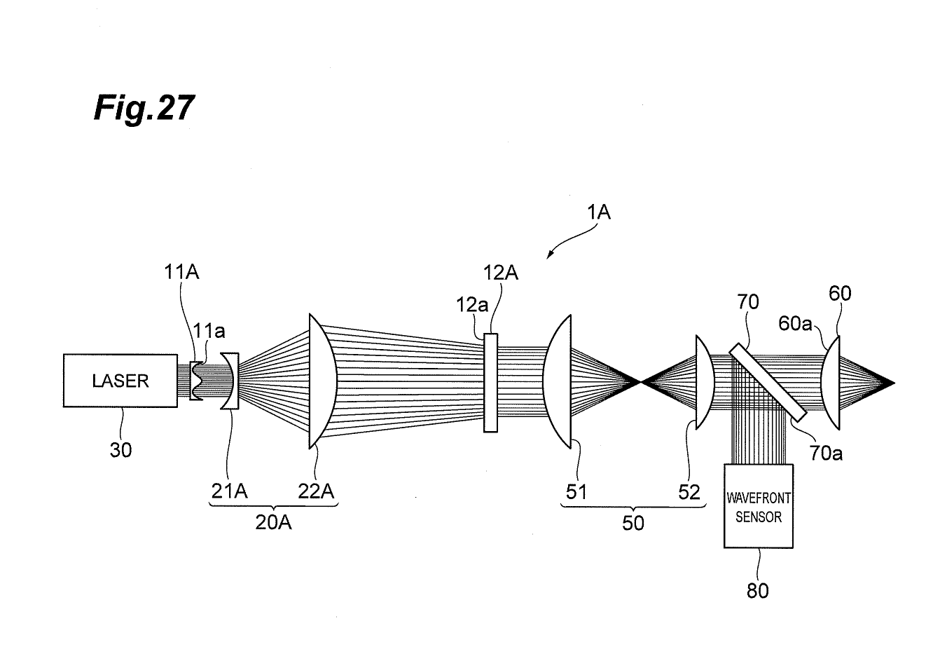

FIG. 27 is a structural diagram illustrating the laser light shaping and wavefront controlling optical system in accordance with a modified example. The laser light shaping and wavefront controlling optical system in accordance with the modified example illustrated in FIG. 27 further comprises an image-forming optical system 50, a condenser lens 60, a beam splitter 70, and a wavefront sensor 80 on the downstream side of the laser light shaping and wavefront controlling optical system 1A in accordance with the second embodiment.

The image-forming optical system 50 is constituted by a pair of convex lenses 51, 52 and causes the laser light on the entrance-side imaging plane to form an image on the exit-side imaging plane. The entrance-side imaging plane of the image-forming optical system 50 is set to the plane where the laser light emitted from the intensity conversion lens 11A has a desirable intensity distribution and the modulation surface 12a of the SLM 12A, while the exit-side imaging plane is set to a pupil plane 60a of the condenser lens 60. This can more strictly transfer the desirable intensity distribution shaped by the intensity conversion lens 11A and the wavefront controlled by the SLM 12A to the condenser lens 60. When the modulation surface 12a of the SLM 12A does not strictly coincide with the plane where the laser light emitted from the intensity conversion lens 11A has the desirable intensity distribution as mentioned above, the entrance-side imaging plane of the image-forming optical system 50 may be set between the plane where the laser light emitted from the intensity conversion lens 11A has the desirable intensity distribution and the modulation surface 12a of the SLM 12A.

The condenser lens 60 converges the laser light from the image-forming optical system 50 at a desirable position, e.g., a processing position within a transparent medium. The beam splitter 70 is arranged between the condenser lens 60 and the image-forming optical system 50.

The beam splitter 70, which is arranged such that its entrance surface 70a forms an angle of about 45° with the laser light from the image-forming optical system 50, reflects a part of the laser light from the image-forming optical system 50, so as to guide it to the wavefront sensor 80. On the other hand, the beam splitter 70 transmits therethrough the remainder of the laser light from the image-forming optical system 50, so as to guide it to the condenser lens 60. A movable mirror or the like may be used in place of the beam splitter 70.

The optical path length from the exit surface of the image-forming optical system 50 to the wavefront sensor 80 is set equal to that from the exit surface of the image-forming optical system 50 to the pupil plane 60a of the condenser lens 60. This lets the wavefront sensor 80 measure the wavefront at a position corresponding to the pupil plane 60a of the condenser lens 60.

Then, the correction wavefront of the SLM 12A is set or adjusted such as to yield a desirable wavefront at the pupil plane 60a of the condenser lens 60 according to the wavefront measured by the wavefront sensor 80.

What is claimed is:

1. A laser light shaping and wavefront controlling optical system comprising:
an intensity conversion lens for converging and shaping an intensity distribution of laser light incident thereon into a desirable intensity distribution;
a light modulator for modulating the laser light emitted from the intensity conversion lens so as to perform wavefront control; and
an expansion/reduction optical system, arranged between the intensity conversion lens and the light modulator, for expanding or reducing the laser light emitted from the intensity conversion lens.

2. A laser light shaping and wavefront controlling optical system according to claim 1, wherein the expansion/reduction optical system is constituted by a pair of convex lenses.

3. A laser light shaping and wavefront controlling optical system according to claim 1, wherein the expansion/reduction optical system is constituted by a pair of concave and convex lenses.

4. A laser light shaping and wavefront controlling optical system according to claim 1, wherein the modulation surface of the light modulator is located at a plane where the laser light emitted from the intensity conversion lens has the desirable intensity distribution.
